(19) United States
(12) Patent Application Publication
(10) Pub. No.: US 2012/0184244 A1
(43) Pub. Date: Jul. 19, 2012

(54) ONLINE CHARGING IN IMS NETWORKS FOR SESSIONS HANDED OVER BETWEEN DIFFERENT OPERATOR NETWORKS

(76) Inventors: Yigang Cai, Naperville, IL (US); Xiangyang Li, PuDong Jinqiao (CN)

(21) Appl. No.: 13/498,944

(22) PCT Filed: Sep. 30, 2009
(86) PCT No.: PCT/CN2009/074347

§ 371 Date: Mar. 29, 2012

(51) Int. Cl. H04W 4/26

(52) U.S. Cl. 455/408

(57) ABSTRACT

IMS networks and methods are disclosed for providing online charging for a session of an IMS device that is seamlessly handed over between a first IMS network and a second IMS network that are different operator networks. A roaming charging identifier (RCID) is assigned to the session that is global to a dialog of the session over the first IMS network and to a dialog of the session over the second IMS network. A network element is able to correlate online charging information for the different dialogs of the session based on the RCID, and send an online charging request for a quota of service units to an online charging system that includes the correlated online charging system. The online charging system can thus rate the session and grant the quota based on the correlated online charging information.

### BACKGROUND

1. Field of the Invention

The invention is related to the field of communication networks and, in particular, to providing for online charging in IMS networks for sessions that are handed over between different operator networks.

2. Statement of the Problem

One type of communication network gaining popularity is an IP Multimedia Subsystem (IMS) network. As set forth in the 3^{rd} Generation Partnership Project (3GPP), the IMS provides a common core network having a network architecture that allows for various types of access networks. The access network between a communication device and the IMS network may be a cellular network (e.g., CDMA or GSM), a WLAN (e.g., WiFi or WiMAX), an Ethernet network, or another type of wireless or wireline access network. The IMS architecture is initially defined by the 3GPP to provide multimedia services to communication devices over an Internet Protocol (IP) network, as IP networks have become the most cost savings bearer network to transmit video, voice, and data. Service providers are accepting this architecture in next generation network evolution.

For a typical session (or call) within an IMS network, user equipment (UE) of an IMS end user initiates the session through an access network, such as a CDMA network, a GSM network, an IP network, a WiFi network, a WiMAX network, etc, by transmitting the appropriate signaling messages (i.e., SIP messages). The access network then routes the signaling messages to the IMS network. A serving-call session control function (S-CSCF) in the IMS network receives the signaling messages and attempts to establish the session in the appropriate manner. When the session is established, the S-CSCF may also contact one or more application servers (AS) in the IMS network to provide services for the session, such as voicemail, call forwarding, etc.

The 3GPP has also defined a charging architecture for the IMS networks that includes an online charging system. The online charging system (OCS) provides prepaid charging, meaning that the IMS user has to have an account balance prior to services being provided, and the account balance is debited as the services are provided.

The OCS includes an online charging function, an account balance management function (ABMF), and a rating function (RF). The ABMF maintains an amount of service units in an account of an IMS user. The rating function determines the cost of service usage according to a tariff defined by the network operator. The online charging function utilizes the ABMF and the rating function in order to perform online charging.

The network elements in the IMS network, such as a Proxy-Call Session Control Function (P-CSCF), a Serving-Call Session Control Function (S-CSCF), an application server (AS), may include Charging Trigger Functions (CTF). These CTFs are adapted to monitor service usage and to generate online charging requests responsive to detecting charging events. The CTFs then transmit the online charging requests to the OCS to provide online charging for the service usage.

Online charging may be performed as direct debiting or unit reservation. For direct debiting, the online charging function debits the units immediately from the account of the IMS user for an individual transaction. For unit reservation, the online charging function grants a quota of units from the account of the IMS user, and provides the quota of units to the requesting network element. The requesting network element then performs budget control by monitoring service usage and deducting from the quota accordingly. If the quota of units expires, then the network element requests another quota of units, and the process continues. After the service has terminated, the total amount of units to deduct from the IMS user's account is resolved.

The following illustrates an example of charging for a session in an IMS network. An IMS user either initiates or is invited into a session through the appropriate signaling message, such as a SIP INVITE. An S-CSCF is assigned to the IMS user to manage the session, so the signaling message goes through the S-CSCF. Responsive to receiving the signaling message for the IMS user, the S-CSCF contacts a Home Subscriber Server (HSS) to access the subscriber profile for the IMS user. The subscriber profile, among other things, indicates the level of service subscribed to by the IMS user, any supplementary services subscribed to by the user, etc. The subscriber profile also indicates that the IMS user is a prepaid user. Thus, responsive to detecting the start of the session, a CTF in the S-CSCF (or in an IMS gateway function as suggested by some of the 3GPP technical specifications) initiates online charging for the session. To initiate online charging, the CTF generates a Diameter Ro Credit Control Request (CCR)[initial] indicating the start of the session, and transmits the CCR[initial] to the OCS.

The online charging function in the OCS then processes information in the CCR[initial] to identify the IMS user, to determine the media type for the session, etc, and accesses the rating function with this and other online charging information to determine a rating for the session. The online charging function also accesses the ABMF to determine whether the IMS user has a sufficient account balance to initiate the session, and if so, to determine how many service units to grant for the session. The online charging function then generates a Credit Control Answer (CCA)[initial], and transmits the CCA[initial] to the S-CSCF (or the IMS gateway function. The CCA[initial] indicates that the session is allowed, and also indicates the quota of service units granted for the session.

The S-CSCF (or the IMS gateway function) receives the CCA[initial] message, and performs budget control. For budget control, the S-CSCF identifies the quota of service units, and decrements the quota as the session continues. If the CTF in the S-CSCF identifies another charging event, then the S-CSCF generates a CCR[update]. For example, a charging event may comprise receiving a SIP 200 OK acknowledging a SIP INVITE, a SIP re-INVITE, or a SIP UPDATE, may comprise the expiration of the quota of service units, may comprise the expiration of a validity timer, etc. The S-CSCF transmits the CCR[update] to the OCS. The online charging function in the OCS performs similar processes to grant another quota of service units (if available) for the session, generates a CCA[update], and transmits the CCA[update] to the S-CSCF. The CCA[update] indicates that the session is allowed to continue, and also indicates the new quota of service units granted for the session.

The S-CSCF (or the IMS gateway function) receives the CCA[update], and again performs budget control on the newly granted quota. Assume at some later time that the session ends. Responsive to identifying the end of the session, the CTF in the S-CSCF generates a CCR[termination], and transmits the CCR[termination] to the OCS. The CCR[termination] indicates the number of service units used for the session (either for duration of the session or for the latest slice of the quota granted by the online charging function). The online charging function then resolves the total debit for the session from the account of the IMS user in the ABMF.

An IMS end user may roam out of his/her home network and into a visited network. When this occurs, the session may be seamlessly handed over from the home network to the visited network so that the session may continue without interruption. One network element that assists in the seamless handover of sessions from one network to another is referred to as a Voice Call Continuity (VCC) application server.

One problem encountered by service providers is performing online charging when a session is handed over between different operator networks when the IMS end user is roaming. When an IMS end user roams from a first operator network (e.g., the home network) to a second operator network (i.e., the visited network) and the session is handed over (e.g., through the VCC application server), the 3GPP standards do not provide any solution for online charging.

### SUMMARY

Embodiments described herein provide for seamless online charging for a session that is handed over between different operator networks. When a session is initiated and the session is allowed to be handed over between a first IMS network and a second IMS network (i.e., different operator networks), there will be multiple dialogs established for the session. A roaming charging identifier (RCID) is assigned for the session that is global to the dialogs. The RCID is distributed to network elements for online charging. When an online charging event is identified in a network element, the network element correlates online charging information for multiple dialogs of the session, and inserts the correlated online charging information in an online charging request to the online charging system. The online charging system may then rate the session and grant a quota based on the correlated online charging information. As a result, online charging may be seamlessly performed for the session even though it was handed over between different operator networks.

One embodiment comprises a network element that is operable to receive a session initiation message (e.g., a SIP INVITE) for a session that is allowed to be handed over between a first IMS network and a second IMS network. The first IMS network and the second IMS network are operated by different network operators. The network element is further operable to assign a roaming charging identifier (RCID) for the session that is global to a dialog of the session over the first IMS network and to a dialog of the session over the second IMS network. The network element is further operable to distribute the roaming charging identifier to other network elements for online charging.

Another embodiment comprises a system for providing online charging. The system includes a network element operable to perform budget control for a session over the first IMS network based on a quota of service units granted by an online charging system. The network element is further operable to identify an online charging event after the session is handed over from the first IMS network to the second IMS network, and to generate an online charging request for a new quota of service units responsive to the online charging event. The network element is further operable to identify the RCID assigned to the session, and to correlate online charging information for the dialog of the session over the first IMS network with online charging information for the dialog of the session over the second IMS network based on the RCID. The network element is further operable to insert the correlated online charging information in the online charging request, and to transmit the online charging request to the online charging system.

In another embodiment, the network element is further operable to receive an online charging response from the online charging system indicating the new quota of service units that is granted based on the correlated online charging information, and to perform budget control for the session over the second IMS network based on the new quota of service units.

The invention may include other exemplary embodiments described below.

### DESCRIPTION OF THE DRAWINGS

Some embodiments of the present invention are now described, by way of example only, and with reference to the accompanying drawings. The same reference number represents the same element or the same type of element on all drawings.

FIG. 1 illustrates a communication network in an exemplary embodiment.

FIG. 2 is a flow chart illustrating a method of performing online charging for a session in an exemplary embodiment.

FIG. 3 is a flow chart illustrating a method of processing an online charging request in an online charging system in an exemplary embodiment.

FIG. 4 is a flow chart illustrating a method of providing budget control in an exemplary embodiment.

FIG. 5 is a flow chart illustrating a method of assigning a Roaming Charging Identifier (RCID) for a handover session in an exemplary embodiment.

FIG. 6 is a flow chart illustrating a method of performing online charging after handover in an exemplary embodiment.

FIGS. 7-11 are message diagrams illustrating a session handed over between different operator networks in an exemplary embodiment.

### DESCRIPTION OF EMBODIMENTS

The figures and the following description illustrate specific exemplary embodiments of the invention. It will thus be appreciated that those skilled in the art will be able to devise various arrangements that, although not explicitly described or shown herein, embody the principles of the invention and are included within the scope of the invention. Furthermore, any examples described herein are intended to aid in understanding the principles of the invention, and are to be construed as being without limitation to such specifically recited examples and conditions. As a result, the invention is not limited to the specific embodiments or examples described below, but by the claims and their equivalents.

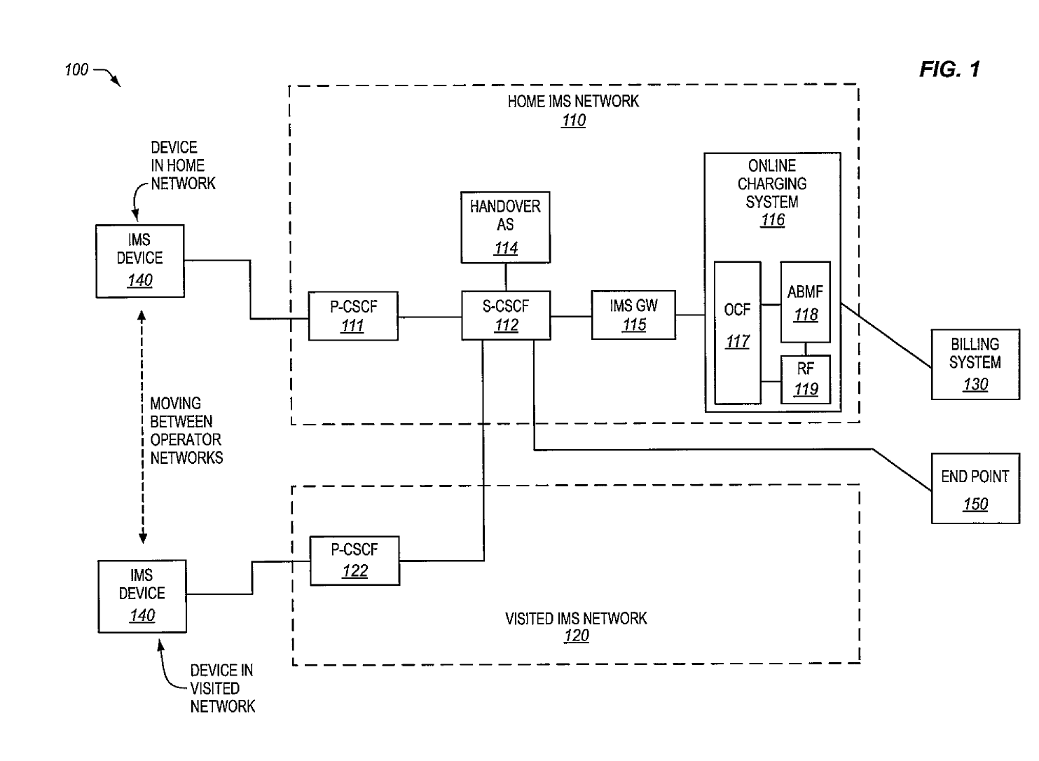

FIG. 1 illustrates a communication network 100 in an exemplary embodiment. Communication network 100 includes a home IMS network 110, a visited IMS network 120, and billing system 130. Home IMS network 110 includes a proxy-call session control function (P-CSCF) 111, a serving-call session control function (S-CSCF) 112, a handover application server 114 (which may also be referred to as a Voice Call Continuity (VCC) application server), an IMS gateway system 115, and an online charging system (OCS) 116. Home IMS network 110 may include other network elements that are not shown for the sake of brevity, such as a Breakout Gateway Control Function (BGCF), a Media Gateway Control Function (MGCF), etc. Visited IMS network 120 includes a P-CSCF 122. Like home IMS network 110, visited IMS network 120 may include other network elements that are not shown for the sake of brevity. Billing system 130 comprises any system, server, or function adapted to process charging data records (CDRs) to generate or resolve a bill for a session in home IMS network 110.

Each of home IMS network 110 and visited IMS network 120 may be connected to an access network (not shown). IMS networks allows for a variety of types of access to an IMS device (also referred to as user equipment (UE)). For instance, an IMS access network may comprise a cellular network, such as a CDMA network or a GSM network. An IMS access network may comprise a wireless LAN, such as a WiFi network or WiMAX network. Home IMS network 110 and visited IMS network 120 may have similar access networks or may have different access networks in order to communicate with IMS device 140.

Within home IMS network 110, P-CSCF 111 and S-CSCF 112 comprise any systems, servers, or functions operable to establish, maintain, or tear down a session in home IMS network 110. Handover application server (AS) 114 comprises any system, server, or function adapted to provide a handover service for a session of IMS device 140. Handover application server 114 may comprise a Voice Call Continuity (VCC) application server that is operable to provide voice call continuity when an IMS user is moving between a Circuit Switched (CS) domain and an IMS domain. The handover application server or VCC application server may include a mobile management AS option (not shown) and a network domain selection function (not shown) to perform handover between different wireless domains. Handover application server 114 processes signaling messages for the session to provide a handover from home IMS network 110 to visited IMS network 120 (or vice-versa) without interruption of the session.

IMS gateway system 115 comprises any system, server, or function operable to act as a service interface toward S-CSCF 112, and to act as a charging interface towards OCS 116. For example, IMS gateway system 115 may interface with S-CSCF 112 over an ISC interface, and may interface with OCS 116 over a Diameter Ro interface.

OCS 116 comprises any system, server, or function operable to provide online charging for a session. In this embodiment, OCS 116 includes an online charging function (OCF) 117, an Account Balance Management Function (ABMF) 118, and a rating function (RF) 119. OCF 117 comprises any system, server, or function operable to manage online charging in OCS 116 by accessing ABMF 118 and RF 119, exchanging online charging messages with network elements, such as IMS gateway system 115, and performing other functions. ABMF 118 comprises any system, server, or function operable to maintain accounts for IMS users, and more particularly to maintain an amount of service units in the accounts of the IMS users. RF 119 comprises any system, server, or function operable to determine the cost of service usage according to a tariff defined by the network operator.

In the embodiments provided herein, home IMS network 110 and visited IMS network 120 represent different operator networks. An operator network refers to an IMS core network owned, controlled, managed, and/or operated by a communication service provider. An example of one service provider may be Verizon Wireless that manages one operator network to provide mobile services, and another service provider may be AT&T that manages another operator network. In the embodiments below, one may assume that home IMS network 110 is controlled by service provider A while visited IMS network 120 is controlled by service provider B.

The embodiments described herein provide call continuity when a session (or call) is handed over from one operator network to a different operator network, and provides seamless online charging capability for the session that is handed over. Presently, when an IMS device roams from a first operator network (e.g., home IMS network 110) to a second operator network (e.g., visited IMS network 120), there is no effective way to continue to perform online charging for the session.

Systems and methods described below provide seamless online charging for sessions that are handed over between different operator networks. A roaming charging identifier (RCID) is assigned for the session, and the RCID is used to correlate online charging information for a handover session, such as in IMS gateway system 115. IMS gateway system 115 is able to correlate online charging information for a dialog over home IMS network 110 and for a dialog over visited IMS network 120, and provide an online charging request to OCS 116 that includes the correlated online charging information. OCS 116 may then rate the session based on the correlated online charging information, and provide a quota of service units for the session based on the correlated online charging information. Because the rate and quota are for multiple dialogs of the session, online charging is seamless even though there was a handover between different operator networks.

Assume that IMS device 140 initially registers with home IMS network 110 and initiates a session with an end point 150 by transmitting a session initiation message (e.g., a SIP INVITE) to home IMS network 110. S-CSCF 112 receives the session initiation message for the session, and processes initial filter criteria (iFC) for IMS device 140 to identify that IMS device 140 is allowed handover between different operator networks. The iFC provides an address for handover application server 114. Thus, S-CSCF 112 forwards the session initiation message to handover application server 114 to allow for seamless handover during the session. In response to the session initiation message, handover application server 114 initiates another dialog for the session by transmitting another session initiation message back to S-CSCF 112. This happens because handover application server 114 is a B2BUA. S-CSCF 112 then forwards the session initiation message to end point 150. At this point, there is one dialog set up between IMS device 140 and handover application server 114 over home IMS network 110, and another dialog set up between handover application server 114 and end point 150. A dialog as described herein is a SIP sub-session. Because handover application server 114 is a B2BUA, multiple SIP message flows are used for a session. Each SIP message flow may thus represent a dialog (also referred to as a session leg).

When the session is initiated over home IMS network 110, a network element in home IMS network 110 assigns a first IMS Charging Identifier (ICID) to the session. The ICID is related to one or more dialogs for the session established through home IMS network 110. As an example of assigning an ICID, if IMS device 140 initiates the session in home IMS network 110 with a session initiation message (e.g., SIP INVITE), then P-CSCF 111 in home IMS network 110 may assign the ICID that is unique to one or more dialogs over home IMS network 110.

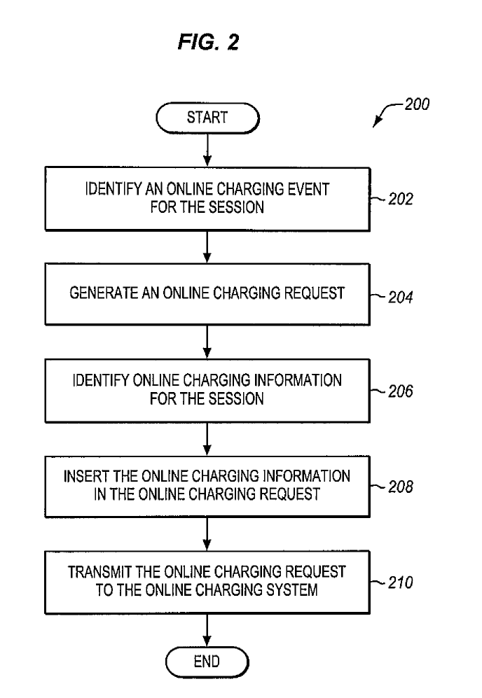

P-CSCF 111, IMS gateway system 115 (or S-CSCF 112), handover application server 114 or another network element that is serving the session may include Charging Trigger Functions (CTF) that are defined to provide online charging for the session. FIG. 2 is a flow chart illustrating a method 200 of performing online charging for a session in an exemplary embodiment. The steps of method 200 will be described with reference to communication network 100 in FIG. 1, but those skilled in the art will appreciate that method 200 may be performed in other networks and systems. Also, the steps of the flow charts described herein are not all inclusive and may include other steps not shown, and the steps may be performed in an alternative order.

In step 202, a CTF in a network element (e.g., IMS gateway system 115) identifies or detects an online charging event for online charging for the session. For example, the network element may receive a session initiation message that triggers online charging for the session. In response to the online charging event, the network element generates an online charging request for the session in step 204. The online charging request may be an initial, update, or termination message. As an example, the online charging request may comprise a Credit Control Request (CCR) [initial, update, termination] as defined in Diameter Ro protocol.

In step 206, the network element identifies online charging information for the session. Online charging information comprises any context information for the session that allows OCS 116 to rate the session and grant a quota for the session (if allowed). For example, the online charging information may include originating and destination network identities, originating and destination device data (addresses), a media type for the session, an ICID for the session, service specific information, etc. In step 208, the network element inserts the online charging information in the online charging request, and transmits the online charging request to OCS 116 in step 210.

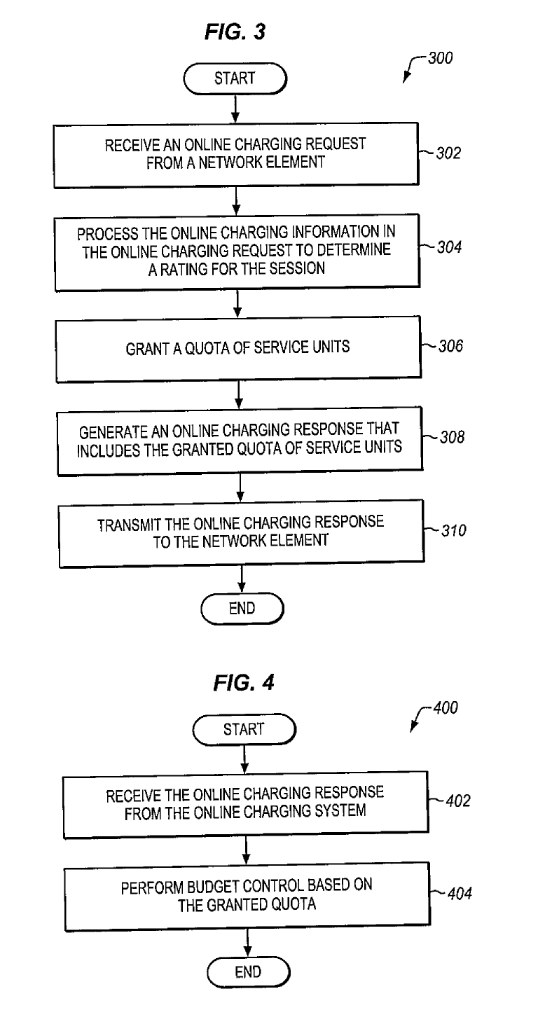

FIG. 3 is a flow chart illustrating a method 300 of processing the online charging request in OCS 116 in an exemplary embodiment. The steps of method 300 will be described with reference to communication network 100 in FIG. 1, but those skilled in the art will appreciate that method 300 may be performed in other networks and systems.

In step 302, OCF 117 in OCS 116 receives the online charging request from the network element in home IMS network 110 (i.e., IMS gateway system 115) that is requesting a quota for the session. OCF 117 processes the online charging request to identify the online charging information for the session. In step 304, OCF 117 accesses RF 119 with the online charging information to determine a rating for the session. OCF 117 also accesses ABMF 118 to determine whether the IMS user has a sufficient account balance to initiate the session, and if so, to determine how many service units to grant for the session. In step 306, OCF 117 grants a quota of service units (or credits) from the account of the IMS user based on the rating, the account balance, etc. OCF 117 then generates an online charging response that includes the granted quota of service units in step 308. One example of the online charging response comprises a Diameter Ro Credit Control Answer (CCA) [initial, update, termination] as defined in Diameter Ro protocol. OCF 117 then transmits the online charging response to the network element in step 310. After the network element receives the online charging response with the granted quota, the network element may provide budget control for the session.

FIG. 4 is a flow chart illustrating a method 400 of providing budget control in an exemplary embodiment. The steps of method 400 will be described with reference to communication network 100 in FIG. 1, but those skilled in the art will appreciate that method 400 may be performed in other networks and systems.

In step 402, the network element receives the online charging response from OCS 116. In step 404, the network element performs budget control for the session based on the granted quota. The quota relates to the ICID that was included in the online charging request. As the session progresses, the network element decrements service units from the granted quota. The network element also monitors the consumption of the service units to see if the quota is used up. If the granted quota is used up, then the network element will request a new quota from OCS 116 with another online charging request.

In FIG. 1, assume at some point that a user of IMS device 140 roams from a service area of home IMS network 110 to a service area of visited IMS network 120. When IMS device 140 enters the service area of visited IMS network 120, IMS device 140 registers with visited IMS network 120. IMS device 140 then transmits a session initiation message (e.g., SIP INVITE) to P-CSCF 122 in visited IMS network 120. P-CSCF 122 forwards the session initiation message to S-CSCF 112 in home IMS network 110. S-CSCF 112 receives the session initiation message, and forwards the session initiation message to handover application server 114 so that handover application server 114 may assist in transferring the session to visited IMS network 120. Because of the functionality of handover application server 114, the session continues uninterrupted over visited IMS network 120.

The session initiation message received by handover application server 114 represents another dialog for the session. At this point, there is a new dialog set up between IMS device 140 and handover application server 114 over visited IMS network 120 (instead of over home IMS network 110 because IMS device 140 is now roaming). At initiation of the new dialog, a network element in visited IMS network 120 will assign a new ICID for the session. For example, P-CSCF 122 may assign the new ICID for the session. The following describes how online charging may be performed seamlessly for the handover session even though different dialogs of the session are assigned different ICIDs.

To provide seamless online charging in a handover scenario, a roaming charging identifier (RCID) is assigned for the session. An RCID comprises any number, code, string, etc, that is assigned to a session in the event that the session is handed over between different operator networks. The RCID is global for the session and is not associated with any particular dialog of the session. The dialog(s) over home IMS network 110 are assigned one ICID while the dialog(s) over visited IMS network 120 are assigned another ICID. The RCID is assigned in addition to the ICIDs to be global among the dialogs of the session. Thus, a network element may correlate online charging information for multiple dialogs based on the RCID so that OCS 116 can rate the session and grant quotas based on the correlated online charging information.

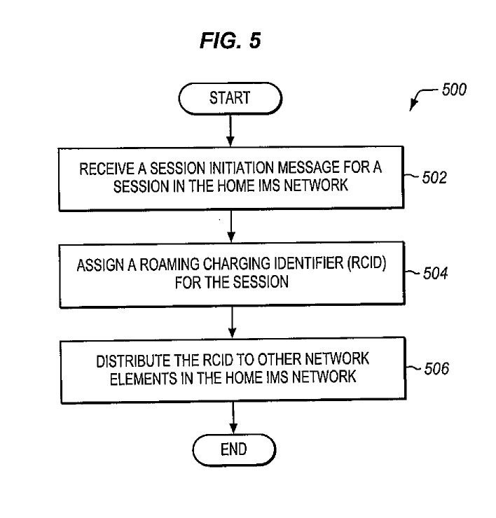

The RCID may be assigned in a desired network element of home IMS network 110, such as handover application server 114, and distributed to the other network elements. One embodiment for assigning the RCID is illustrated in FIG. 5.

FIG. 5 is a flow chart illustrating a method 500 of assigning an RCID for the handover session in an exemplary embodiment. The steps of method 500 will be described with reference to communication network 100 in FIG. 1, but those skilled in the art will appreciate that method 500 may be performed in other networks and systems.

In this embodiment, the RCID is assigned in handover application server 114. To do so, handover application server 114 receives a session initiation message (i.e., SIP INVITE) for the session from S-CSCF 112 in step 502. In step 504, handover application server 114 assigns the RCID for the session. In step 506, handover application server 114 distributes the RCID to other network elements in home IMS network 110. For example, handover application server 114 may reply to a first session initiation message from S-CSCF 112 with a second session initiation message (handover application server 114 is a B2BUA). Handover application server 114 inserts the RCID in the second session initiation message so that S-CSCF 112 is notified of the RCID. S-CSCF 112 may then process the second session initiation message to identify the RCID, and store the RCID for online charging. S-CSCF 112 may also forward a session initiation message to IMS gateway system 115 so that IMS gateway system 115 may store the RCID for online charging. Other network elements may operate in a similar manner to store the RCID for online charging. Those skilled in the art will appreciate that network elements other than handover application server 114 may operate in a similar manner to assign the RCID. Now that the network elements in home IMS network 110 have received and stored the RCID, the network elements use the RCID for online charging.

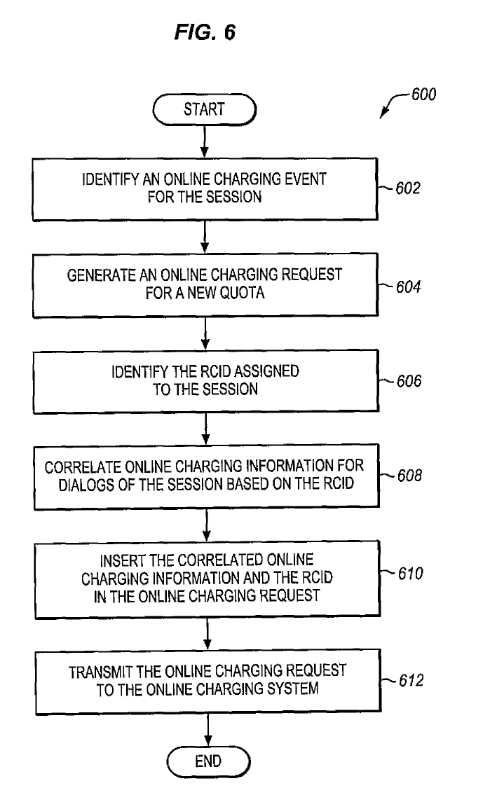

FIG. 6 is a flow chart illustrating a method 600 of performing online charging after handover in an exemplary embodiment. The steps of method 600 will be described with reference to communication network 100 in FIG. 1, but those skilled in the art will appreciate that method 600 may be performed in other networks and systems.

In step 602, a CTF in the network element (e.g., IMS gateway system 115) identifies or detects an online charging event after the session is handed over. For example, the network element may receive a session initiation message that triggers online charging for the session, such as a SIP re-INVITE indicating the transfer of the session from home IMS network 110 to visited IMS network 120. In response to the online charging event, the network element generates an online charging request for a new quota of service units in step 604. In step 606, the network element identifies the RCID assigned to the session. The network element may have previously stored the RCID that was assigned to the session in the event that the session is handed over. In step 608, the network element correlates online charging information for the dialog(s) of the session over home IMS network 110 with online charging information for the dialog(s) of the session over visited IMS network 120 based on the RCID. This is advantageous because the online charging information could not be correlated prior to assigning the RCID to the session. As described above, the dialog over home IMS network 110 has a different ICID than the dialog over visited IMS network 120. Thus, the online charging information for these dialogs could not be correlated. The RCID allows the online charging information to be correlated in the network element, which effectively creates a single correlated charging transaction for the session even though the session includes multiple dialogs that are associated with different ICIDs.

In step 610, the network element inserts the correlated online charging information and the RCID in the online charging request. The network element may insert the online charging information and the RCID in the Application Server Information AVP in a Diameter CCR, as one example. In step 612, the network element transmits the online charging request to OCS 116.

OCS 116 may then process the online charging request as described in FIG. 3. OCF 117 in OCS 116 receives the online charging request from the network element that is requesting a quota for the session (step 302). OCF 117 then processes the online charging request to identify the correlated online charging information for the session. OCF 117 accesses RF 119 with the correlated online charging information to determine a rating for the session (step 304). OCF 117 also accesses ABMF 118 to determine whether the IMS user has a sufficient account balance to initiate the session, and if so, to determine how many service units to grant for the session. OCF 117 grants a new quota of service units from the account of the IMS user based on the rating, the account balance, etc (step 306). Because OCF 117 receives online charging information that is correlated from multiple dialogs, the rating and quota take into account the dialog over home IMS network 110 and the dialog over visited IMS network 120. OCF 117 then generates an online charging response that includes the newly granted quota of service units (step 308), and transmits the online charging response to the network element (step 310).

The network element receives the online charging response from OCS 116 as described in FIG. 4 (step 402). The online charging response includes the new quota of service units that is to be used for budget control after handover of the session. The network element then performs budget control for the session based on the newly granted quota (step 404). The network element may advantageously apply the granted quota to multiple dialogs of the session that relate to the RCID. For example, the network element may apply the granted quota to the existing dialog of the session and to the new dialog of the session. Thus, even though two dialogs of the session may have different ICIDs, the network element does not need to request a separate quota for each dialog, and does not need to perform separate budget control for the dialogs. This allows for seamless online charging even though the session was handed over between different operator networks.

If another handover occurs from visited IMS network 120 back to home IMS network 110 or to another operator network which is not shown in FIG. 1, then a similar process is performed to correlate the online charging information for the session based on the RCID, and request a quota from OCS 116 based on correlated online charging information. Thus, budget control may be performed within a network element on the session as a whole, and not on individual dialogs of the session.

Although the above embodiment describes the handover of a session from home IMS network 110 to visited IMS network 120, seamless online charging may apply to handovers from visited IMS network 120 to home IMS network 110, or from visited IMS network 120 to another visited IMS network that is not shown in FIG. 1.

### Example

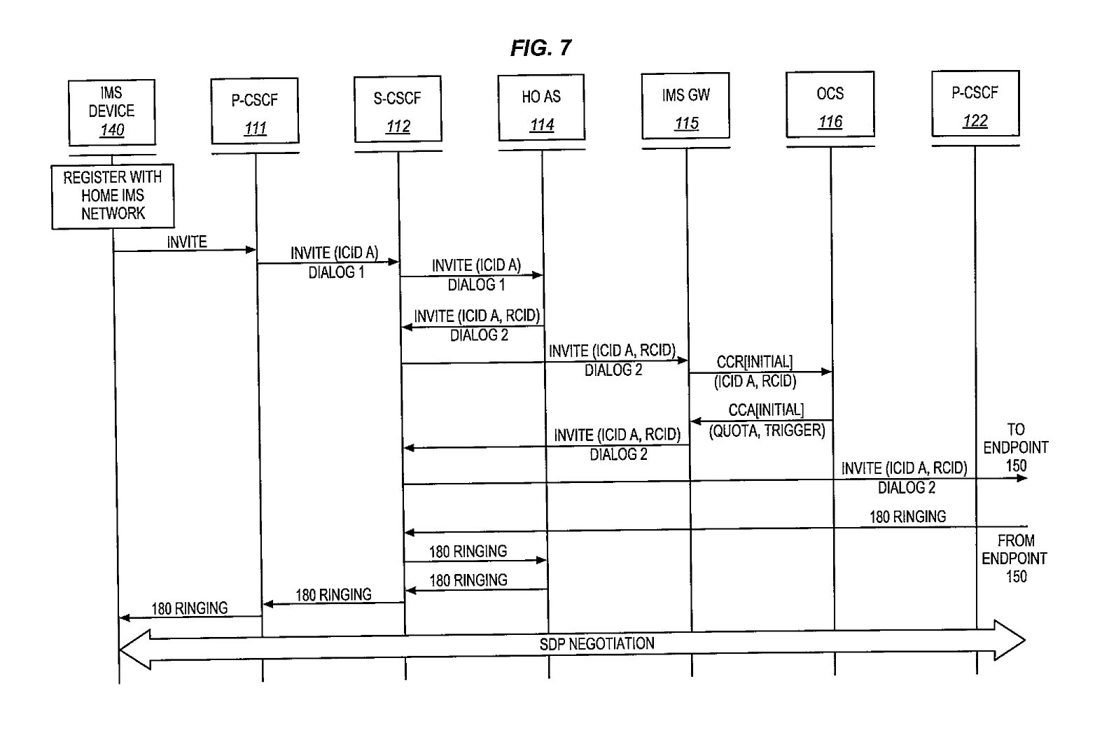

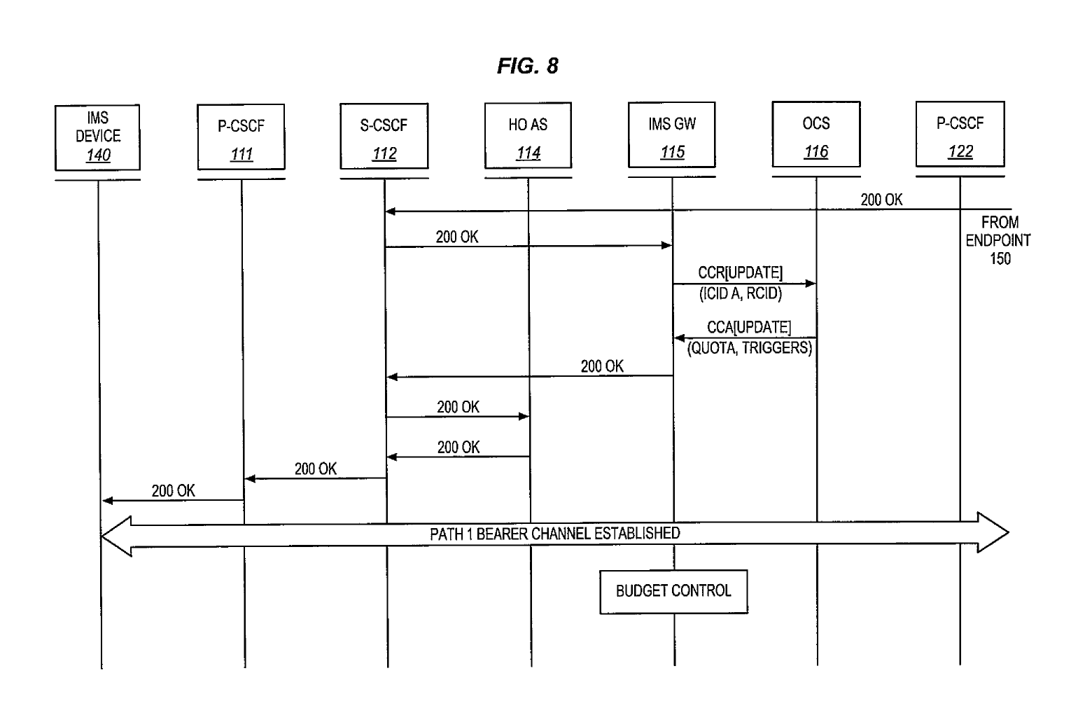

FIGS. 7-11 are message diagrams illustrating a session handed over between different operator networks in an exemplary embodiment. The message diagram illustrates SIP and Diameter messaging used within communication network 100, although other protocols may be used in other embodiments.

To start, IMS device 140 registers with home IMS network 110. To initiate the session in FIG. 7, IMS device 140 generates a SIP INVITE and transmits the SIP INVITE to P-CSCF 111 in home IMS network 110. P-CSCF 111 assigns an ICID for the session (ICID A), and inserts the ICID in the P-Charging-Vector of the SIP INVITE. P-CSCF 111 then forwards the SIP INVITE to S-CSCF 112 (dialog 1). Responsive to receiving the SIP INVITE, S-CSCF 112 processes initial filter criteria (iFC) for IMS device 140, which indicates that IMS device 140 is allowed handover between different operator networks. The iFC for IMS device 140 also includes an address for handover application server 114. Thus, S-CSCF 112 includes handover application server 114 (HO AS) in the session by transmitting the SIP INVITE to handover application server 114.

In response to the SIP INVITE, handover application server 114 assigns a roaming charging identifier (RCID) for the session. Handover application server 114 is a back-to-back user agent (B2BUA) in this embodiment (as is S-CSCF 112), so handover application server 114 sets up another dialog for the call. To do so, handover application server 114 transmits a SIP INVITE (dialog 2) back to S-CSCF 112 with ICID A and the RCID. S-CSCF 112 processes the SIP INVITE to identify the RCID assigned by handover application server 114, and stores the RCID for online charging. S-CSCF 112 then transmits the SIP INVITE to IMS gateway system 115.

The SIP INVITE is a trigger for the CTF in IMS gateway system 115. Thus, IMS gateway system 115 generates a Diameter CCR[initial] in response to the SIP INVITE, and inserts ICID A and the RCID in the CCR[initial]. IMS gateway system 115 also inserts online charging information in the CCR[initial], such as an identity for the IMS user, a media type of the session, etc. IMS gateway system 115 then transmits the CCR[initial] to OCS 116 to request a quota for the session.

OCF 117 (see also FIG. 1) in OCS 116 processes the CCR[initial] to identify the online charging information for the session, and accesses RF 119 with the online charging information to determine a rating for the session. OCF 117 also accesses ABMF 118 to determine whether the IMS user has a sufficient account balance to initiate the session, and if so, to determine how many service units to grant for the session. OCF 117 then grants a quota of service units from the account of the IMS user based on the rating, the account balance, etc, and transmits a Diameter CCA[initial] to IMS gateway system 115 that indicates that the session is allowed, and also indicates the quota of service units granted for the session.

Further, based on the online charging information, OCS 116 processes roaming charging rules to determine whether to set one or more triggers in IMS gateway system 115 to charge for a handover session. If the triggers are to be set, OCS 116 further includes the triggers in the CCA[initial]. The triggers indicate to IMS gateway system 115 that OCS 116 supports roaming charging.

IMS gateway system 115 receives the CCA[initial], and identifies the granted quota for budget control. Based on the armed triggers, IMS gateway system 115 maintains the online charging information for the session until the session ends. IMS gateway system 115 then transmits the SIP INVITE back to S-CSCF 112, and S-CSCF 112 forwards the SIP INVITE to end point 150. End point 150 responds to IMS device 140 with a SIP 180 ringing, and IMS device 140 and end point 150 begin SDP negotiation.

In FIG. 8, when SDP negotiation has finished, end point 150 transmits a SIP 200 OK to S-CSCF 112, which forwards the SIP 200 OK back to IMS device 140 through handover application server 114, IMS gateway system 115, and P-CSCF 111. The SIP 200 OK is a trigger for the CTF in IMS gateway system 115. Thus, IMS gateway system 115 generates a Diameter CCR[update] to reauthorize the session based on the negotiated SDP information, and inserts ICID A and the RCID in the CCR[update]. IMS gateway system 115 also inserts updated online charging information in the CCR[update] based on the negotiated SDP information. IMS gateway system 115 then transmits the CCR[update] to OCS 116.

OCS 116 again processes the online charging information in the CCR[update] to reauthorize the session. OCS 116 transmits a Diameter CCA[update] to IMS gateway system 115 that indicates that the session is allowed, indicates the quota of service units granted for the session, and indicates any related triggers.

When the SIP 200 OK is routed to IMS device 140, a bearer channel is established for the session between IMS device 140 and end point 150 (referred to herein as path 1), which is typically a Realtime Transport Protocol (RTP) channel. IMS device 140 and end point 150 may then communicate during the session via voice, text, multimedia, etc. IMS gateway system 115 performs budget control for the session based on the granted quota, and monitors credit consumption. If the granted quota is used up, IMS gateway system 115 will request a new quota from OCS 116 with another CCR[update] (not shown in FIG. 8).

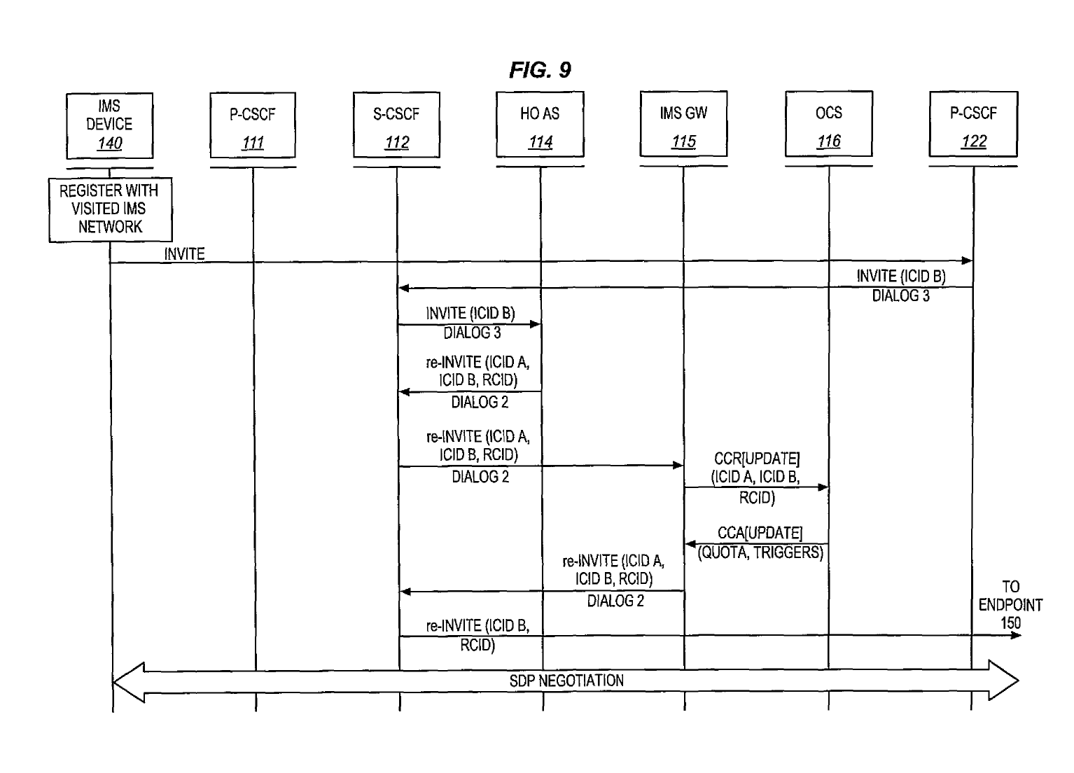

Assume that during the session, IMS device 140 moves to a service area of visited IMS network 120 and out of the service area of home IMS network 110. IMS device 140 is thus roaming in visited IMS network 120, and the session is to be handed over from home IMS network 110 to visited IMS network 120. In FIG. 9, to facilitate the hand over, IMS device 140 registers with visited IMS network 120, and then sends a SIP INVITE to P-CSCF 122 in visited IMS network 120. P-CSCF 122 assigns another ICID to the session, which is referred to as ICID B. P-CSCF 122 then transmits the SIP INVITE to S-CSCF 112 in home IMS network 110, as home IMS network 110 still provides call control. The SIP INVITE includes ICID B, which is inserted in the P-Charging-Vector of the SIP INVITE. Because IMS device 140 is now roaming, the dialog (dialog 3) for the side of the IMS device 140 is now associated with ICID B instead of ICID A.

S-CSCF 112 transmits the SIP INVITE to handover application server 114 for dialog 3. Handover application server 114 transmits a SIP re-INVITE message back to S-CSCF 112. The SIP re-INVITE includes both ICID A and ICID B, and also includes the RCID. Because the SIP re-INVITE includes the RCID, S-CSCF 112 is able to associate dialog 3 with the RCID. S-CSCF 112 transmits the SIP re-INVITE to IMS gateway system 115.

The SIP re-INVITE is a trigger for the CTF in IMS gateway system 115 based on the triggers set by OCS 116. Before sending the CCR[update] to OCS 116, IMS gateway system 115 correlates dialogs for the session that relate to the same RCID. In this example, dialog 2 relates to ICID A and represents a sub-session over home IMS network 110. Dialog 3 relates to ICID B and represents the sub-session over visited IMS network 120 now that IMS device 140 is roaming. These dialogs are related by the RCID. Thus, IMS gateway system 115 correlates the online charging information for these two dialogs based on the RCID. IMS gateway system 115 then generates a Diameter CCR[update] to request a new quota for the session, and inserts ICID A, ICID B, and the RCID in the CCR[update]. IMS gateway system 115 also inserts the correlated online charging information for the dialogs in the CCR[update]. The correlated online charging information may include the unused serviced units for the session. IMS gateway system 115 then transmits the CCR[update] to OCS 116.

OCF 117 (see also FIG. 1) in OCS 116 processes the CCR[update] to identify the correlated online charging information for the session, and accesses RF 119 with the correlated online charging information to determine a rating for the sub-session over home IMS network 110. OCF 117 then accesses ABMF 118 to return the unused service units to the account balance of the IMS user. OCF 117 also re-rates the session based on the correlated online charging information, and grants a quota of service units from the account of the IMS user based on the rating for the sub-session over visited IMS network 120. OCF 117 transmits a Diameter CCA[update] to IMS gateway system 115 that indicates the new quota of service units granted for the session. IMS gateway system 115 then transmits the SIP re-INVITE back to S-CSCF 112, and S-CSCF 112 forwards the re-SIP INVITE to end point 150. At this point, IMS device 140 and end point 150 may perform SDP negotiation again.

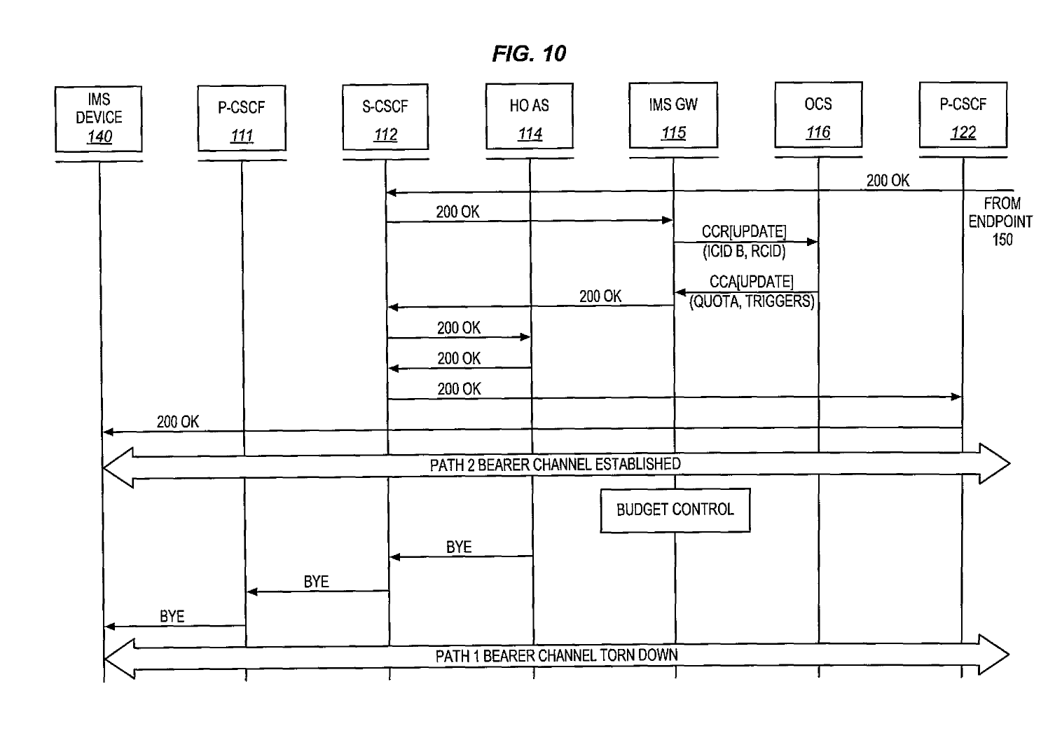

In FIG. 10, end point 150 responds with a SIP 200 OK to S-CSCF 112, which forwards the SIP 200 OK back to IMS device 140 through handover application server 114, IMS gateway system 115, and P-CSCF 122. The SIP 200 OK is again a trigger for the CTF in IMS gateway system 115. Thus, IMS gateway system 115 generates a Diameter CCR[update] to reauthorize the session based on the negotiated SDP information, and inserts ICID B and the RCID in the CCR[update]. IMS gateway system 115 also inserts updated online charging information in the CCR[update] based on the negotiated SDP information. IMS gateway system 115 then transmits the CCR[update] to OCS 116.

OCS 116 again processes the online charging information in the CCR[update] to reauthorize the session. OCS 116 transmits a Diameter CCA[update] to IMS gateway system 115 that indicates that the session is allowed, indicates the quota of service units granted for the session, and indicates any related triggers.

When the SIP 200 OK is routed to IMS device 140, a bearer channel is established for the session between IMS device 140 and end point 150 (referred to herein as path 2), with the session now over visited IMS network 120. IMS device 140 and end point 150 may then communicate during the session via voice, text, multimedia, etc. IMS gateway system 115 performs budget control for the session based on the newly granted quota, and monitors credit consumption. If the newly granted quota is used up, IMS gateway system 115 will request a new quota from OCS 116 with another CCR[update] (not shown in FIG. 10).

After handover is completed, handover application server 114 initiates the tear down the original dialog 1. Handover application server 114 thus generates a SIP BYE, and transmits the SIP BYE to IMS device 140 through S-CSCF 112 and P-CSCF 111. Path 1 is then torn down as the session between IMS device 140 and end point 150 is now over path 2.

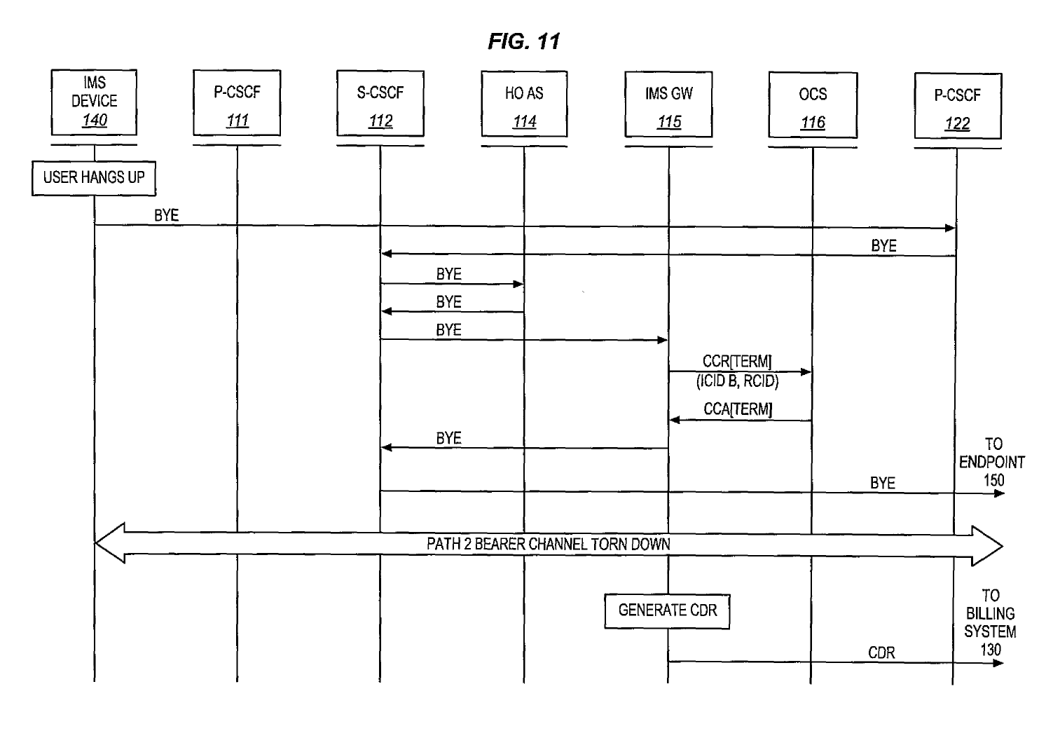

In FIG. 11, assume at some later point that IMS device 140 terminates the session. IMS device 140 terminates the session by sending a SIP BYE to P-CSCF 122. P-CSCF 122 transmits the SIP BYE to S-CSCF 112, which forwards the SIP BYE to end point 150 through handover application server 114 and IMS gateway system 115. The SIP BYE is a trigger for the CTF in IMS gateway system 115 to end online charging. Thus, IMS gateway system 115 generates a Diameter CCR[termination] to end the credit session, and inserts ICID B and the RCID in the CCR[termination]. IMS gateway system 115 also includes any unused service units for the session in the CCR[termination]. IMS gateway system 115 then transmits the CCR[termination] to OCS 116.

OCF 117 (see also FIG. 1) in OCS 116 processes the CCR[termination] to identify the end of the session, and accesses ABMF 118 to return the unused service units to the account balance of the IMS user. OCF 117 then transmits a Diameter CCA[termination] to IMS gateway system 115.

Additional SIP messages may then be exchanged to tear down the path 2 and end the session. OCS 116 then generates a Charging Data Record (CDR) for online charging. The CDR correlates charging information associated with all sub-sessions, all related timestamps, and other parameters. OCS 116 then forwards the CDR to billing system 130 in home IMS network 100 (see FIG. 1). Billing system 130 will then negotiate with the visited IMS network 120 to settle revenue sharing for the session.

Any of the various elements shown in the figures or described herein may be implemented as hardware, software, firmware, or some combination of these. For example, an element may be implemented as dedicated hardware. Dedicated hardware elements may be referred to as “processors”, “controllers”, or some similar terminology. When provided by a processor, the functions may be provided by a single dedicated processor, by a single shared processor, or by a plurality of individual processors, some of which may be shared. Moreover, explicit use of the term “processor” or “controller” should not be construed to refer exclusively to hardware capable of executing software, and may implicitly include, without limitation, digital signal processor (DSP) hardware, a network processor, application specific integrated circuit (ASIC) or other circuitry, field programmable gate array (FPGA), read only memory (ROM) for storing software, random access memory (RAM), non volatile storage, logic, or some other physical hardware component or module.

Also, an element may be implemented as instructions executable by a processor or a computer to perform the functions of the element. Some examples of instructions are software, program code, and firmware. The instructions are operational when executed by the processor to direct the processor to perform the functions of the element. The instructions may be stored on storage devices that are readable by the processor. Some examples of the storage devices are digital or solid-state memories, magnetic storage media such as a magnetic disks and magnetic tapes, hard drives, or optically readable digital data storage media.

Although specific embodiments were described herein, the scope of the invention is not limited to those specific embodiments. The scope of the invention is defined by the following claims and any equivalents thereof.

1. A system comprising:
a network element operable to perform budget control for a session over a first IP Multimedia Subsystem (IMS) network based on a quota of service units granted by an online charging system;
the network element further operable to identify an online charging event after the session is handed over from the first IMS network to a second IMS network that are different operator networks, to generate an online charging request for a new quota of service units responsive to the online charging event, to identify a roaming charging identifier assigned to the session that is global to a first dialog of the session over the first IMS network and to a second dialog of the session over the second IMS network, to correlate online charging information for the first dialog with online charging information for the second dialog based on the roaming charging identifier, to insert the correlated online charging information in the online charging request, and to transmit the online charging request to the online charging system.

2. The system of claim 1 further comprising:
the network element further operable to receive an online charging response from the online charging system indicating the new quota of service units that was granted based on the correlated online charging information, and to perform budget control for the session over the second IMS network based on the new quota of service units.

3. The system of claim 1 wherein the roaming charging identifier is generated by a handover application server that provides handover of the session between the first IMS network and the second IMS network, the handover application server comprises a Voice Call Continuity (VCC) application server, and the network element further operable to identify the online charging event responsive to receiving a SIP re-INVITE initiated by the handover application server in transferring the session from the first IMS network to the second IMS network, and to process the SIP re-INVITE to identify the roaming charging identifier.

4. (canceled)

5. (canceled)

6. The system of claim 1 wherein:
the online charging request comprises a Diameter Ro Credit Control Request (CCR); and
the network element is further operable to insert the correlated online charging information in an Application Server Information AVP in the Diameter Ro CCR.

7. The system of claim 1 wherein the correlated online charging information includes an IMS Charging Identifier (ICID) assigned to the first dialog of the session over the first IMS network and includes an ICID assigned to the second dialog of the session over the second IMS network.

8. The system of claim 1 wherein the network element comprises an IMS gateway system implemented between a serving-call session control function (S-CSCF) and the online charging system.

9. A method comprising:
performing budget control for a session over a first IP Multimedia Subsystem (IMS) network based on a quota of service units granted by an online charging system;
identifying an online charging event after the session is handed over from the first IMS network to a second IMS network that are different operator networks;
generating an online charging request for a new quota of service units responsive to the online charging event;
identifying a roaming charging identifier assigned to the session that is global to a first dialog of the session over the first IMS network and to a second dialog of the session over the second IMS network;
correlating online charging information for the first dialog with online charging information for the second dialog based on the roaming charging identifier;
inserting the correlated online charging information in the online charging request; and
transmitting the online charging request to the online charging system.

10. The method of claim 9 further comprising:
receiving an online charging response from the online charging system indicating the new quota of service units that was granted based on the correlated online charging information; and
performing budget control for the session over the second IMS network based on the new quota of service units.

11. The method of claim 9 wherein the roaming charging identifier is generated by a handover application server that provides handover of the session between the first IMS network and the second IMS network, the handover application server comprises a Voice Call Continuity (VCC) application server, and wherein identifying the online charging event comprises:
receiving a SIP re-INVITE initiated by the handover application server in transferring the session from the first IMS network to the second IMS network, and processing the SIP re-INVITE to identify the roaming charging identifier.

12. (canceled)

13. (canceled)

14. The method of claim 9 wherein:
the online charging request comprises a Diameter Ro Credit Control Request (OCR); and
the method further includes inserting the correlated online charging information in an Application Server Information AVP in the Diameter Ro CCR.

15. The method of claim 9 wherein the correlated online charging information includes an IMS Charging Identifier (ICID) assigned to the first dialog of the session over the first IMS network and includes an ICID assigned to the second dialog of the session over the second IMS network.

16. A system comprising:
a network element operable to receive a session initiation message for a session that is allowed to be handed over between a first IP Multimedia Subsystem (IMS) network and a second IMS network that are operated by different network operators, to assign a roaming charging identifier for the session that is global to a first dialog of the session over the first IMS network and to a second dialog of the session over the second IMS network if the session is handed over between the first IMS network and the second IMS network, and to distribute the roaming charging identifier to an IMS gateway system in the first IMS network for online charging.

17. The system of claim 16 wherein the network element comprises a handover application server that is operable to provide a handover of the session between the first IMS network and the second IMS network.

18. The system of claim 16 further comprising:
the IMS gateway system operable to identify an online charging event after the session is handed over between the first IMS network and the second IMS network, to generate an online charging request for a quota of service units responsive to the online charging event, to correlate online charging information for the first dialog with online charging information for the second dialog based on the roaming charging identifier, to insert the correlated online charging information in the online charging request, and to transmit the online charging request to an online charging system, and
the IMS gateway system further operable to receive an online charging response from the online charging system indicating the quota of service units that was granted based on the correlated online charging information, and to perform budget control for the session based on the quota of service units after the session is handed over between the first IMS network and the second IMS network.

19. (canceled)

20. The system of claim 16 wherein the correlated online charging information includes an IMS Charging Identifier (ICID) assigned to the first dialog of the session over the first IMS network and includes an ICID assigned to the second dialog of the session over the second IMS network.
